(19) United States
(12) Patent Application Publication
(10) Pub. No.: US 2023/0189339 A1
(43) Pub. Date: Jun. 15, 2023

(54) RTS AND CTS TRANSMISSION METHOD

(71) Applicant: LG ELECTRONICS INC., Seoul (KR)

(72) Inventors: Jeongki KIM, Seoul (KR); Jinsoo CHOI, Seoul (KR)

(73) Assignee: LG ELECTRONICS INC., Seoul (KR)

(21) Appl. No.: 17/923,969

(22) PCT Filed: Apr. 29, 2021
(86) PCT No.: PCT/KR2021/005477

§ 371 Date: Nov. 8, 2022

(30) Foreign Application Priority Data
May 8, 2020 (KR) 10-2020-0055325
May 8, 2020 (KR) 10-2020-0055461
May 15, 2020 (KR) 10-2020-0058638
May 18, 2020 (KR) 10-2020-0059215

(51) Int. Cl. H04W 74/08

(52) U.S. Cl. CPC H04W 74/0816; H04W 84/12

(57) ABSTRACT

In a wireless local area network system, an RTS frame may include information associated with the length of the RTS frame. The type of information included in the RTS frame may vary according to the length of the RTS frame. In other words, the RTS frame may include information indicating the type of information included in the RTS frame. The information associated with the length of the RTS frame may further include information associated with the wireless LAN system supported by a reception STA that transmits the RTS frame.

### TECHNICAL FIELD

The present disclosure relates to a method for transmission of request to send (RTS) and clear to send (CTS) in a wireless local area network system.

### BACKGROUND

A wireless local area network (WLAN) has been enhanced in various ways. For example, the Institute of Electrical and Electronics Engineers (IEEE) 802.11ax standard has proposed an enhanced communication environment by using orthogonal frequency division multiple access (OFDMA) and downlink multi-user multiple input multiple output (DL MU MIMO) schemes.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

### SUMMARY

In a wireless local area network (WLAN) system according to various embodiments, a station (STA) receives a request to send (RTS) frame, and the RTS frame may include information related to the length of the RTS frame. The STA may transmit a clear to send (CTS) frame, and the CTS frame may include information related to the length of the CTS frame.

If the length of the RTS/CTS frame is increased, for the legacy STAs, the NAVtimeout may end before PPDU transmission starts.

According to an example of the present specification, it is possible to prevent the NAVtimeout from ending before the PPDU transmission starts, and it is possible to secure forward compatibility based on the increase of information included in RTS/CTS in standards prescribed in the future.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates a layout of resource units (RUs) used in a band of 80 MHz.

FIG. 5 illustrates an operation based on UL-MU.

FIG. 6 illustrates an example of a trigger frame.

FIG. 7 illustrates an example of a common information field of a trigger frame.

FIG. 8 illustrates an example of a subfield included in a per user information field.

FIG. 9 illustrates an example of a PPDU used in the present specification.

FIG. 10 illustrates an example of a modified transmission device and/or receiving device of the present specification.

FIG. 11 is a diagram illustrating an example of NAV reset.

FIG. 12 is a diagram illustrating an example of an RTS/CTS/MU-RTS frame.

FIG. 13 is a diagram illustrating an example of an RTS/CTS/MU-RTS frame.

FIG. 14 is a diagram illustrating an example of an RTS/CTS/MU-RTS frame.

FIG. 15 is a diagram illustrating an example of an RTS/CTS/MU-RTS frame.

FIG. 16 is a diagram illustrating an example of an RTS/CTS/MU-RTS frame.

FIG. 17 is a diagram illustrating an example of an RTS/CTS/MU-RTS frame.

FIG. 18 is a diagram illustrating an embodiment of a multi-link transmission method.

FIG. 19 is a diagram illustrating an embodiment of an inter-link interference situation of MLD.

FIG. 20 is a diagram illustrating an example of an operation method of a non-AP STA that does not respond to an RTS/MU-RTS/Trigger frame.

FIG. 21 is a diagram illustrating an embodiment of a method of operating a receiving STA.

FIG. 22 is a diagram illustrating an embodiment of a method of operating a transmitting STA.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11 be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3rd generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

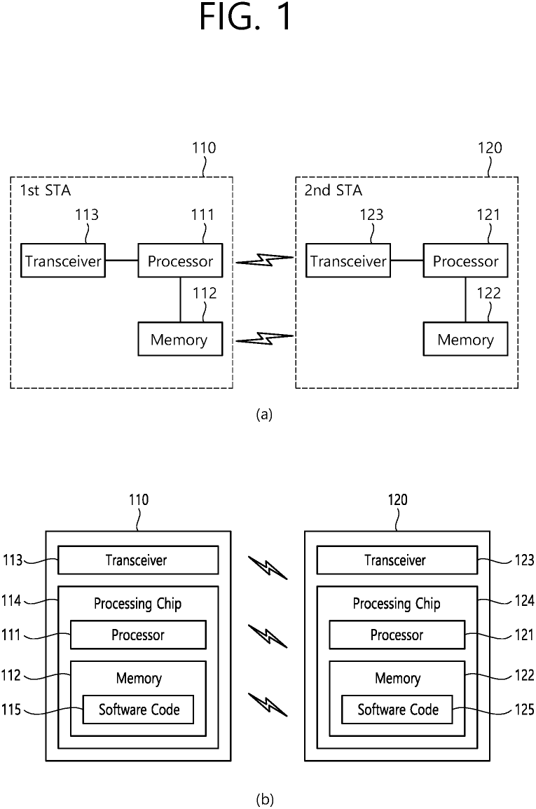

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP. In the present specification, the AP may be indicated as an AP STA.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGONTM series of processors made by Qualcomm®, EXYNOSTM series of processors made by Samsung®, A series of processors made by Apple®, HELIOTM series of processors made by MediaTek®, ATOMTM series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

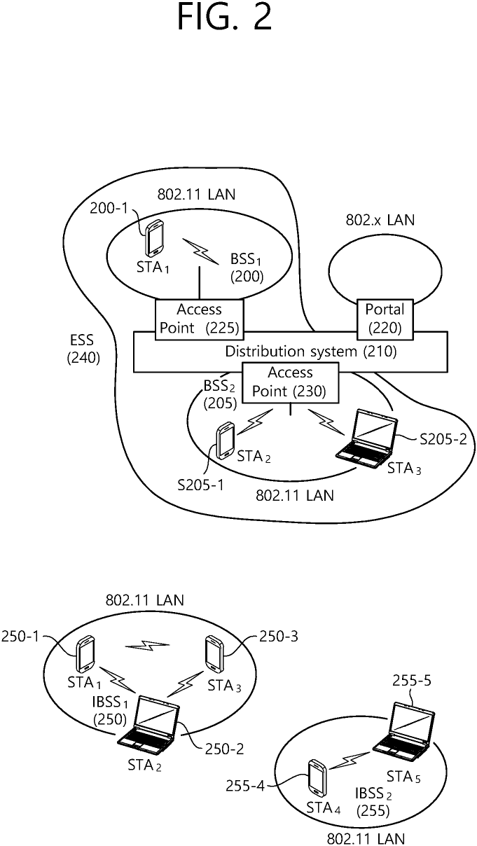

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

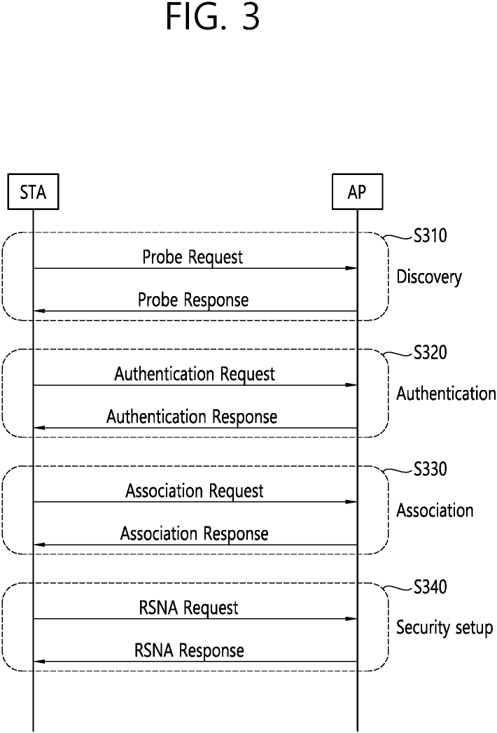

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

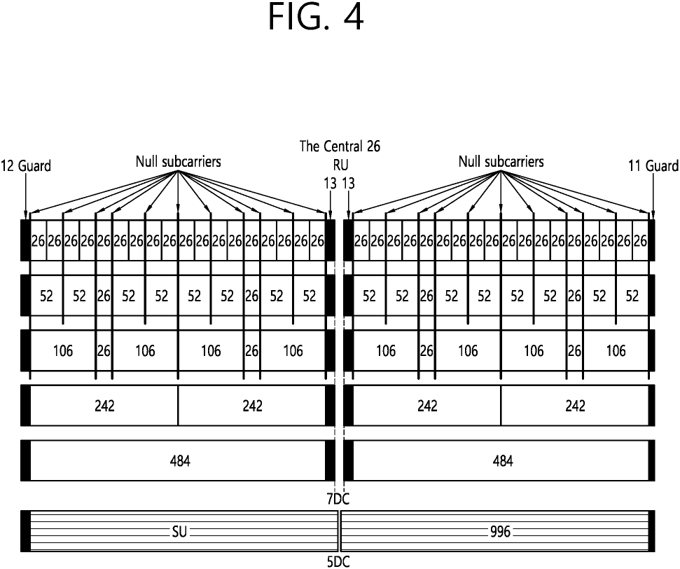

FIG. 4 illustrates a layout of resource units (RUs) used in a band of 80 MHz.

RUs having various sizes such as a 26-RU, a 52-RU, a 106-RU, a 242-RU, a 484-RU, a 996-RU may be used. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

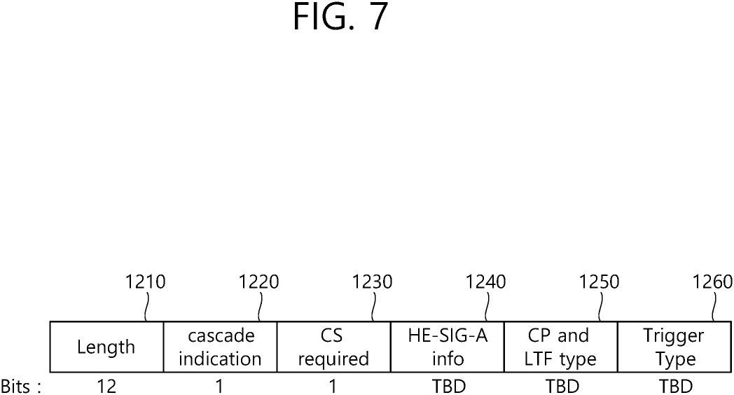

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

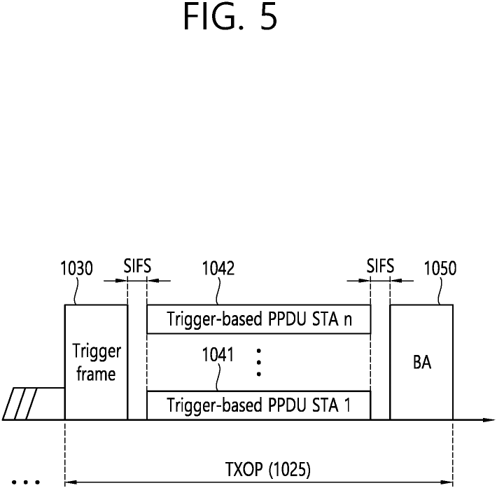

FIG. 5 illustrates an operation based on UL-MU. As illustrated, a transmitting STA (e.g., AP) may perform channel access through contending (e.g., a backoff operation), and may transmit a trigger frame 1030. That is, the transmitting STA may transmit a PPDU including the trigger frame 1030. Upon receiving the PPDU including the trigger frame, a trigger-based (TB) PPDU is transmitted after a delay corresponding to SIFS.

TB PPDUs 1041 and 1042 may be transmitted at the same time period, and may be transmitted from a plurality of STAs (e.g., user STAs) having AIDs indicated in the trigger frame 1030. An ACK frame 1050 for the TB PPDU may be implemented in various forms.

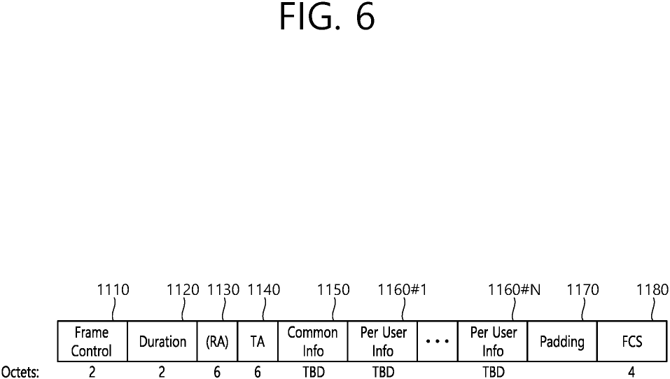

A specific feature of the trigger frame is described with reference to FIG. 6 to FIG. 8. Even if UL-MU communication is used, an orthogonal frequency division multiple access (OFDMA) scheme or a MU MIMO scheme may be used, and the OFDMA and MU-MIMO schemes may be simultaneously used.

FIG. 6 illustrates an example of a trigger frame. The trigger frame of FIG. 6 allocates a resource for uplink multiple-user (MU) transmission, and may be transmitted, for example, from

Each field shown in FIG. 6 may be partially omitted, and another field may be added. In addition, a length of each field may be changed to be different from that shown in the figure.

A frame control field 1110 of FIG. 6 may include information related to a MAC protocol version and extra additional control information. A duration field 1120 may include time information for NAV configuration or information related to an identifier (e.g., AID) of a STA.

In addition, an RA field 1130 may include address information of a receiving STA of a corresponding trigger frame, and may be optionally omitted. A TA field 1140 may include address information of a STA (e.g., AP) which transmits the corresponding trigger frame. A common information field 1150 includes common control information applied to the receiving STA which receives the corresponding trigger frame. For example, a field indicating a length of an L-SIG field of an uplink PPDU transmitted in response to the corresponding trigger frame or information for controlling content of a SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 1160#1 to 1160#N corresponding to the number of receiving STAs which receive the trigger frame of FIG. 6 are preferably included. The per user information field may also be called an “allocation field”.

In addition, the trigger frame of FIG. 6 may include a padding field 1170 and a frame check sequence field 1180.

Each of the per user information fields 1160#1 to 1160#N shown in FIG. 6 may include a plurality of subfields.

FIG. 7 illustrates an example of a common information field of a trigger frame. A subfield of FIG. 7 may be partially omitted, and an extra subfield may be added. In addition, a length of each subfield illustrated may be changed.

A length field 1210 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 1210 of the trigger frame may be used to indicate the length of the corresponding uplink PPDU.

In addition, a cascade identifier field 1220 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmitting device (e.g., AP) may perform downlink communication, and a plurality of transmitting devices (e.g., non-APs) may perform uplink communication.

A CS required field 1230 indicates whether a wireless medium state or a NAV or the like is necessarily considered in a situation where a receiving device which has received a corresponding trigger frame transmits a corresponding uplink PPDU.

An HE-SIG-A information field 1240 may include information for controlling content of a SIG-A field (i.e., HE-SIG-A field) of the uplink PPDU in response to the corresponding trigger frame.

A CP and LTF type field 1250 may include information related to a CP length and LTF length of the uplink PPDU transmitted in response to the corresponding trigger frame. A trigger type field 1260 may indicate a purpose of using the corresponding trigger frame, for example, typical triggering, triggering for beamforming, a request for block ACK/NACK, or the like.

It may be assumed that the trigger type field 1260 of the trigger frame in the present specification indicates a trigger frame of a basic type for typical triggering. For example, the trigger frame of the basic type may be referred to as a basic trigger frame.

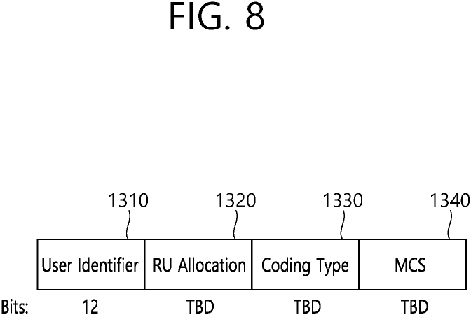

FIG. 8 illustrates an example of a subfield included in a per user information field. A user information field 1300 of FIG. 8 may be understood as any one of the per user information fields 1160#1 to 1160#N mentioned above with reference to FIG. 6. A subfield included in the user information field 1300 of FIG. 8 may be partially omitted, and an extra subfield may be added. In addition, a length of each subfield illustrated may be changed.

A user identifier field 1310 of FIG. 8 indicates an identifier of a STA (i.e., receiving STA) corresponding to per user information. An example of the identifier may be the entirety or part of an association identifier (AID) value of the receiving STA.

In addition, an RU allocation field 1320 may be included. That is, when the receiving STA identified through the user identifier field 1310 transmits a TB PPDU in response to the trigger frame, the TB PPDU is transmitted through an RU indicated by the RU allocation field 1320. In this case, the RU indicated by the RU allocation field 1320 may be an RU shown in FIG. 4.

The subfield of FIG. 8 may include a coding type field 1330. The coding type field 1330 may indicate a coding type of the TB PPDU. For example, when BCC coding is applied to the TB PPDU, the coding type field 1330 may be set to ‘1’, and when LDPC coding is applied, the coding type field 1330 may be set to ‘0’.

In addition, the subfield of FIG. 8 may include an MCS field 1340. The MCS field 1340 may indicate an MCS scheme applied to the TB PPDU. For example, when BCC coding is applied to the TB PPDU, the coding type field 1330 may be set to ‘1’, and when LDPC coding is applied, the coding type field 1330 may be set to ‘0’.

Hereinafter, a PPDU transmitted/received in a STA of the present specification will be described.

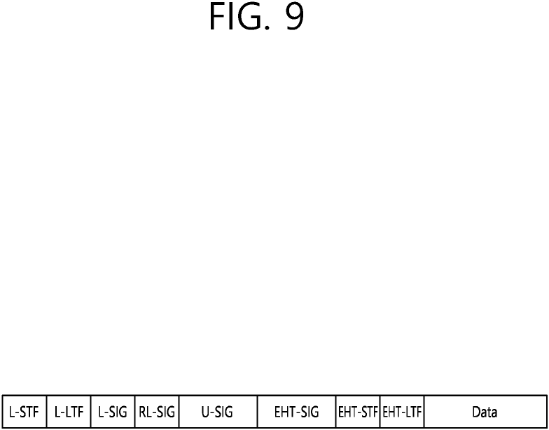

FIG. 9 illustrates an example of a PPDU used in the present specification.

The PPDU of FIG. 9 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 9 may indicate the entirety or part of a PPDU type used in the EHT system. For example, the example of FIG. 9 may be used for both of a single-user (SU) mode and a multi-user (MU) mode. In other words, the PPDU of FIG. 9 may be a PPDU for one receiving STA or a plurality of receiving STAs. When the PPDU of FIG. 9 is used for a trigger-based (TB) mode, the EHT-SIG of FIG. 9 may be omitted. In other words, a STA which has received a trigger frame for uplink-MU (UL-MU) may transmit the PPDU in which the EHT-SIG is omitted in the example of FIG. 9.

In FIG. 9, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 9 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 9, the L-LTF and the L-STF may be the same as those in the conventional fields.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 9. The U-SIG may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4us. Each symbol of the U-SIG may be used to transmit the 26-bit information. For example, each symbol of the U-SIG may be transmitted/received based on 52 data tomes and 4 pilot tones.

The common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 6, each user field may be related to MU-MIMO allocation, or may be related to non-MU-MIMO allocation.

The common field of the EHT-SIG may include a CRC bit and a tail bit. A length of the CRC bit may be determined as 4 bits. A length of the tail bit may be determined as 6 bits, and may be set to ‘000000’.

The common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 9. The PPDU of FIG. 9 may be used to transmit/receive frames of various types. For example, the PPDU of FIG. 9 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 9 may be used for a management frame. An example of the management frame may include a beacon frame, a (re-)association request frame, a (re-)association response frame, a probe request frame, and a probe response frame. For example, the PPDU of FIG. 9 may be used for a data frame. For example, the PPDU of FIG. 9 may be used to simultaneously transmit at least two or more of the control frame, the management frame, and the data frame.

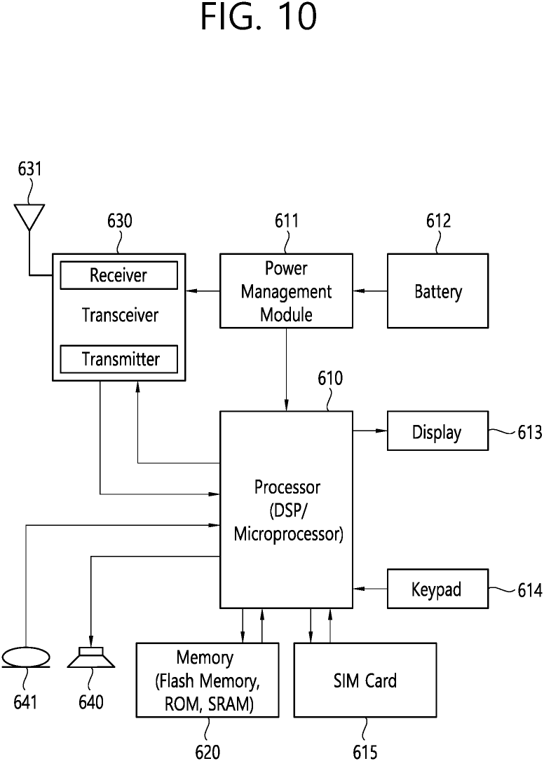

FIG. 10 illustrates an example of a modified transmission device and/or receiving device of the present specification.

Each device/STA of the sub-figure (a)/(b) of FIG. 1 may be modified as shown in FIG. 10. A transceiver 630 of FIG. 10 may be identical to the transceivers 113 and 123 of FIG. 1. The transceiver 630 of FIG. 10 may include a receiver and a transmitter.

A processor 610 of FIG. 10 may be identical to the processors 111 and 121 of FIG. 1. Alternatively, the processor 610 of FIG. 10 may be identical to the processing chips 114 and 124 of FIG. 1.

A memory 620 of FIG. 10 may be identical to the memories 112 and 122 of FIG. 1. Alternatively, the memory 620 of FIG. 10 may be a separate external memory different from the memories 112 and 122 of FIG. 1.

Referring to FIG. 10, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 10, a speaker 640 may output a result related to a sound processed by the processor 610. A microphone 641 may receive an input related to a sound to be used by the processor 610.

### Transmission Rules for 11ax RTS and MU-RTS

If PHY-RXSTART is not detected within a short (e.g., shorter than a typical TXOP period) timeout period (e.g., NAVTimeout) after RTS, the network allocation vector (NAV) reset rule of the baseline (10.3.2.4) may allow an STA that is not a target receiving RTS/MU-RTS to reset the NAV.

NAVTimeout = 2*aSIFSTime + CTS_Time + aRxPHYStartDelay + 2*aSlotTime

If 11ax STA does not recognize new RTS frame (or defined new MU-RTS frame), there is no option to reset the NAV if there is no PHY-RXSTART within the timeout period.

### NAV Setting of 11ax

The STA, that used the information of the RTS frame or MU-RTS trigger frame as the most recent reference to update the NAV setting, may reset the NAV if the PHY-RXSTART.indication primitive is not received from the PHY during the NAVTimeout period. The MAC may receive the PHY-RXEND.indication primitive corresponding to the detection of the RTS frame or the MU-RTS trigger frame.

In Non-DMG BSS, the NAVTimeout period may be equal to (2*aSIFSTime) + (CTS_Time) + aRxPHYStartDelay + (2*aSlotTime). If the MU-RTS trigger frame was used for the latest NAV update, CTS_Time may be calculated using the length of the CTS frame and the 6 Mb/s data rate (see IEEE 802.11 26.2.6 (MU-RTS trigger/CTS frame exchange procedure).

As mentioned above, existing wireless LAN (11a/b/g/n/ac) terminals may reset the NAV set by the RTS if they do not receive the PHY-RXSTART.indication during the NAVTimeout after receiving the RTS. However, since the existing wireless LAN (11a/b/g/n/ac) terminal does not know the MU-RTS defined in 11ax, there is a problem that the existing wireless LAN terminal cannot reset the NAV set by the MU-RTS. Instead, the 11ax terminal may reset the NAV set by the MU-RTS using the above rule. Until now, when a new RTS frame is defined, there have been cases in which the existing wireless LAN terminal cannot reset the NAV because the existing wireless LAN terminal does not know the corresponding frame. For example, when a new RTS/MU-RTS frame is defined in 11be, since terminals supporting the previous WLAN system including 11ax does not know whether the new RTS/MU-RTS frame is RTS/MU-RTS, terminals supporting the previous WLAN system including 11ax cannot apply the NAV resetting rule.

In this specification, a method for solving this problem, that is, a new RTS frame, a CTS frame, and a MU-RTS frame are defined.

In the existing WLAN system, NAVTimeout is set as (2*aSIFSTime) + (CTS_Time) + aRxPHYStartDelay + (2*aSlotTime), but if the above rules are used in an environment using a new CTS frame, the terminal may cause a malfunction. For example, since the length of the new CTS frame may be longer than the length of the existing CTS frame, the NAV may be reset first, and in this case, there may be cases where the NAV is reset before the actual data arrives.

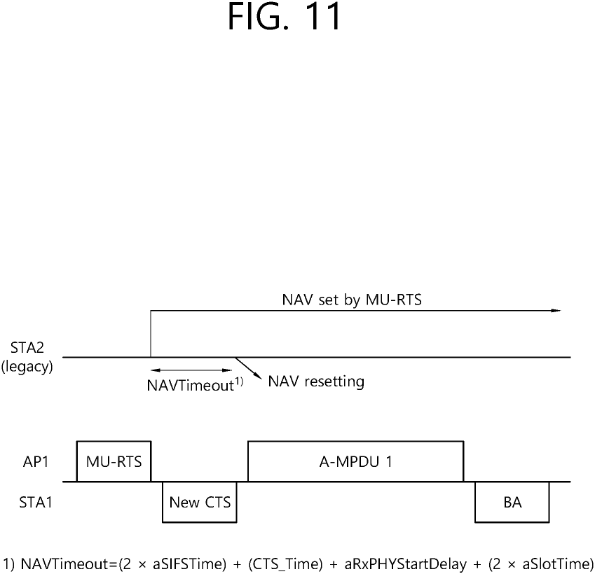

FIG. 11 is a diagram illustrating an example of NAV reset.

Referring to FIG. 11, AP1 may transmit MU-RTS (or new MU-RTS or new RTS) to STA1. STA1 may transmit a new CTS frame having a length longer than that of the existing CTS to AP1. STA2 is a legacy STA that, when receiving RTS or MU-RTS, performs a NAV resetting operation with an existing NAVTimeout. STA2 may be a terminal included in the transmission coverage of API and hidden from STA1. When the STA2 receives the MU-RTS, the STA2 may set the NAV based on Duration information included in the MU-RTS. Thereafter, the STA2 may wait until the NAVTimeout ends, whether the frame is received (i.e., to receive PHY-RXSTART.Indication from the PHY). At this time, since the new CTS frame is longer than the existing CTS frame, STA2 may not receive A-MPDU 1 transmitted by AP 1 during the NAVTimeout, and STA 2 may reset the NAV based on the existing operation.

In this specification, when a new CTS frame is defined together with the new CTS frame, a new NAVTimeout for resetting the NAV may be defined.

In this specification, the terminal (STA) may indicate either an AP STA or a Non-AP STA, unless otherwise specified.

According to an example of the present specification, as the length of the RTS/CTS frame increases, the problem that the NAVtimeout of existing legacy STAs ends before PPDU transmission starts cannot be solved, but even if the length of the RTS/CTS frame is increased in the standards specified later, it is possible to prevent the NAVtimeout from ending before the PPDU transmission starts in the terminals to which the later standards are applied, forward compatibility can be secured as the information included in RTS/CTS increases in the standards to be stipulated in the future.

The newly defined RTS/CTS/MU-RTS frame may include new information, and the existing terminal may not know the new information or the newly defined frame. To solve this problem, the following methods are proposed.

### Method 1: Sufficient Reserved Fields Are Included in the Newly Defined RTS/CTS/MU-RTS Frame

### Method 2: Version Information Indication: Include Version Information in The Newly Defined RTS/CTS/MU-RTS

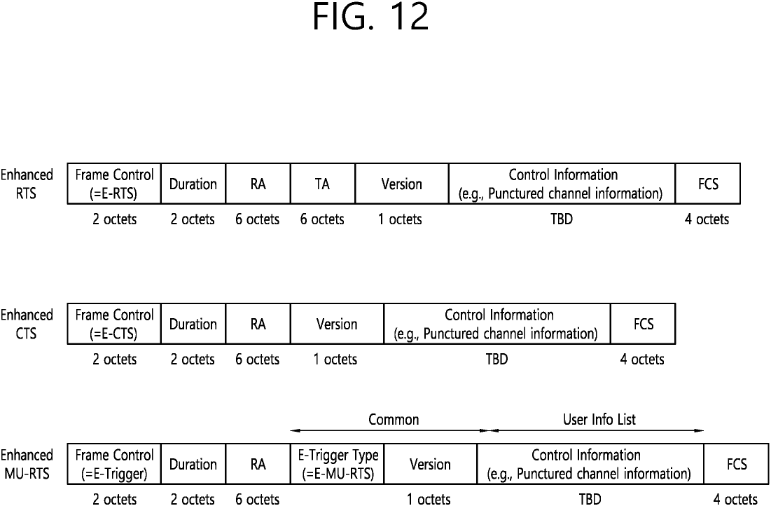

FIG. 12 is a diagram illustrating an example of an RTS/CTS/MU-RTS frame.

Referring to FIG. 12, depending on the Version information, information following the Version information may be different, and the overall length of the frame may be changed based on the included information. That is, the version information may be information related to the length of the frame, and the information related to the frame length may be version information. The Frame control field may include information on a frame type related to which frame the corresponding frame is among RTS/CTS/MU-RTS frames. Or, in the case of MU-RTS, the frame control field may only include information that the corresponding frame is a trigger frame, the E-trigger type field in front of the Version field may include information that the corresponding frame is an Enhanced-MU-RTS frame.

Before the version information appears, it is determined whether the frame is an RTS frame, a CTS frame, or an MU-RTS frame, so that the terminal may know this in advance, the terminal may know how the following information is configured, through Version information.

In FIG. 12, although the size of the Version field is 1 octet, it is natural that it may have a different size (e.g., 4 bits or 16 bits). FIG. 12 shows an example in which Enhanced RTS/CTS/MU-RTS information is indicated in the Frame control field, but may be indicated in other forms.

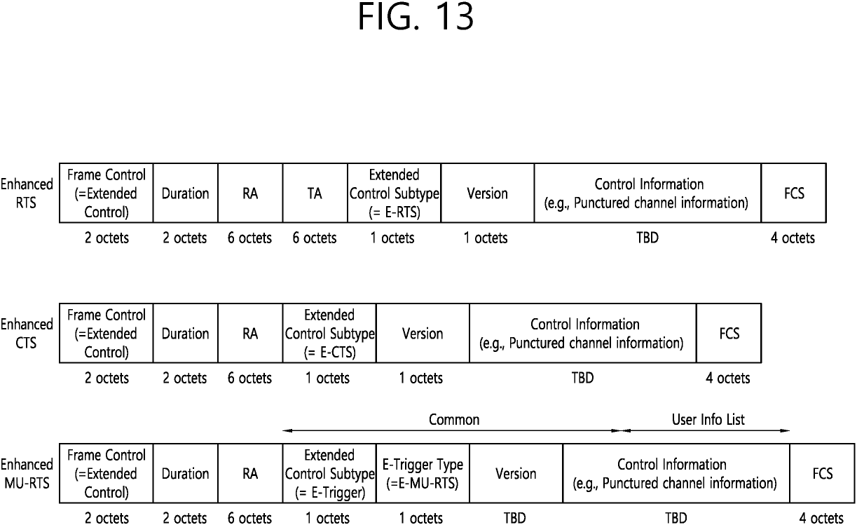

FIG. 13 is a diagram illustrating an example of an RTS/CTS/MU-RTS frame.

Refer to 13, the Frame Control field of the frame includes information called Extended Control frame, after FC (frame control), for example, one subtype field (e.g., Extended Control Subtype) in front of Version information may indicate that the frame is which type of frame (e.g., E-RTS, E-CTS, E-RTS, E-CTS, E-Trigger) among Extended Control frames. For example, if the Extended control subtype field includes information that the frame is E-trigger, a field subsequent to the extended control subtype field may include information related to which type of frame (e.g., E-MU-RTS frame) among E-trigger frames.

Also, in the above examples, the version information is located after TA in E-RTS and after RA in E-CTS, but the version information may be included in a different form or in a different location.

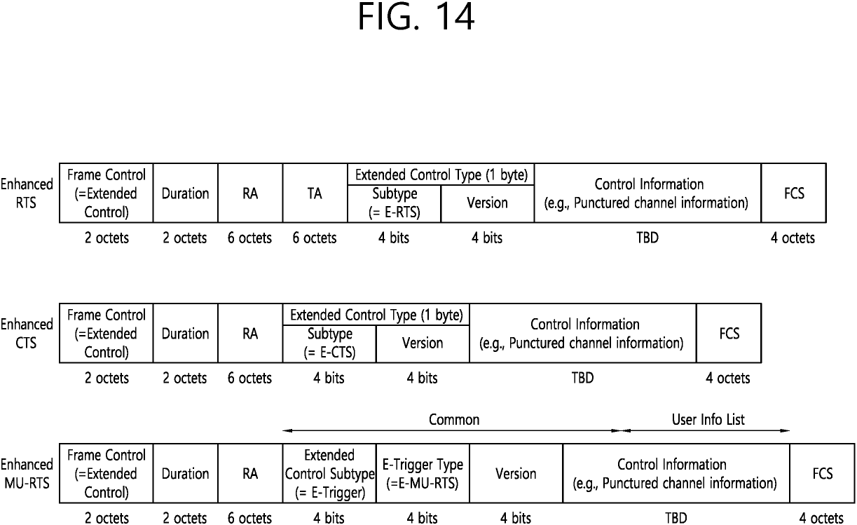

FIG. 14 is a diagram illustrating an example of an RTS/CTS/MU-RTS frame.

Referring to FIG. 14, version information may be indicated using, for example, one or more fields of Frame Control, Duration, RA, and TA. As another example, when configured in the above Extended Control frame format, Version information may be indicated using some bits of Extended Control Subtype. For example, if the Frame control field of a frame contains information related to extended control, the corresponding frame may include an extended control type field, and the extended control type field may include a subtype field and a version field. Here, the subtype field may include information that the corresponding frame is an E-RTS or E-CTS frame, the version field may include information related to the version of the corresponding frame. Alternatively, if the Frame control field of the frame includes the Extended control field, the corresponding frame may include the Extended control subtype field, when the extended control subtype field indicates a trigger frame type, the extended control subtype field may further include a continuous E-trigger type field. For example, the E-trigger type field may include information that the corresponding frame is an E-MU-RTS frame, the version field subsequent to the E-trigger type field may include information related to the version of the corresponding frame.

### Method 3: Include Length Information in the Frame

The frame may include the length instead of the Version. Alternatively, both version information and length information may be included. If the length of control information of E-RTS/E-CTS/E-MU-RTS previously defined is different from the Control information of the newly defined E-RTS/E-CTS/E-MU-RTS frame, based on the Length value, the terminal may determine whether to obtain Control information from the received E-RTS//E-CTS/E-MU-RTS. For example, if terminal A can only know the Control Information structure for Length=X, when a control frame including Control Information with Length = Y is received, terminal A cannot obtain Control Information, and only knows what type of frame (e.g., E-RTS/E-CTS/E-MU-RTS) the corresponding frame is. If terminal B can know the control information structure for Length=X and Length=Y, when receiving a control frame for Length=X or Y, it can obtain information included in the frame. That is, the information related to the frame length may include the type of the corresponding frame and information included in the corresponding frame.

According to an example of the present specification, when version information is included in a new control frame of specific types, when the terminal of the previous version receives the frame of the same type of the later version, although it is not possible to accurately obtain the information included in Control Information, at least it is possible to know which frame the received frame is an extended version of. For example, if the terminal receiving the frame knows that the frame is an E-RTS or E-MU-RTS frame, after the previous version terminal receives the new version of E-RTS or E-MU-RTS and sets the NAV, if it does not receive PHY-RXSTART. Indication during the NAVTimeout, the terminal may reset the NAV. That is, the frame may include information related to the type of the corresponding frame (e.g., RTS, CTS, MU-RTS, etc.) and information related to version (or length).

Method for configuring Control Information field information based on Version information

Option 1: Control Information is configured regardless of version.

For example, the control information of the previous version may not be included in the frame of the next version. In this case, the terminal that understands only the control frame of the previous version may not be able to decode the control frame included in the control frame of the new version.

Option 2: The control information of the next version includes the control information of the previous version.

For example, if Control Information of Version = 1 includes punctured channel information, versions after Version = 2 may always include punctured channel information. In this case, the control information of the lower version (e.g., version = 1) may be located before the control information of the higher version (e.g., version = 2). That is, the information of the next version may be included immediately following the control information of the previous version. This method has an advantage in that STAs designed in the previous version can obtain at least control information that they understand even if they receive the frame of the next version.

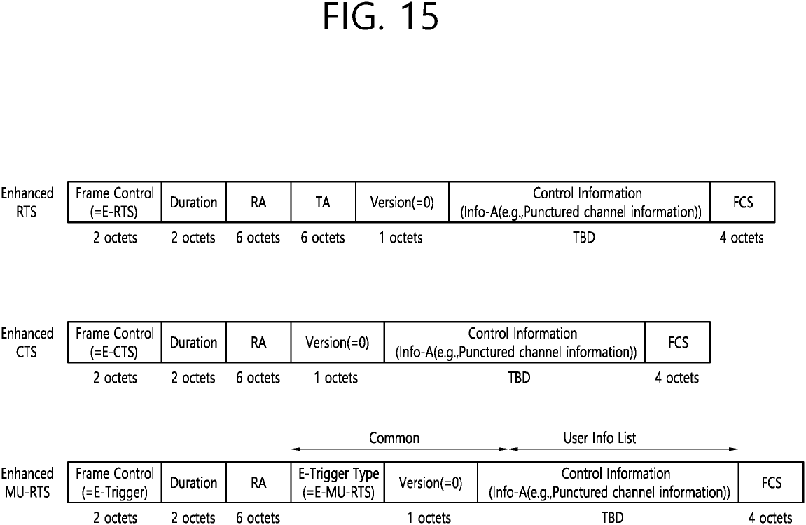

FIG. 15 is a diagram illustrating an example of an RTS/CTS/MU-RTS frame.

Referring to FIG. 15 , in the example of Option 2, when Version 0, Control information may include Info-A (e.g., Punctured channel information).

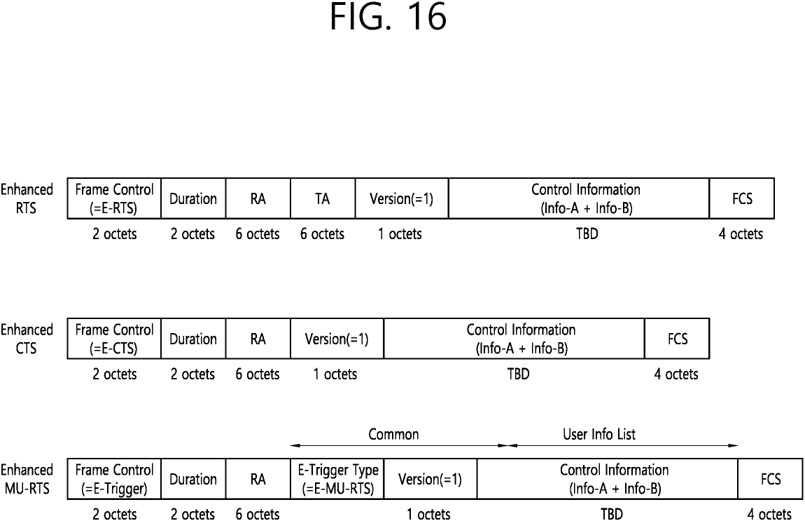

FIG. 16 is a diagram illustrating an example of an RTS/CTS/MU-RTS frame.

Referring to FIG. 16, in the example of Option 2, when Version = 1, Control Information may include additional information (Info-B) in addition to information Info-A when Version = 0.

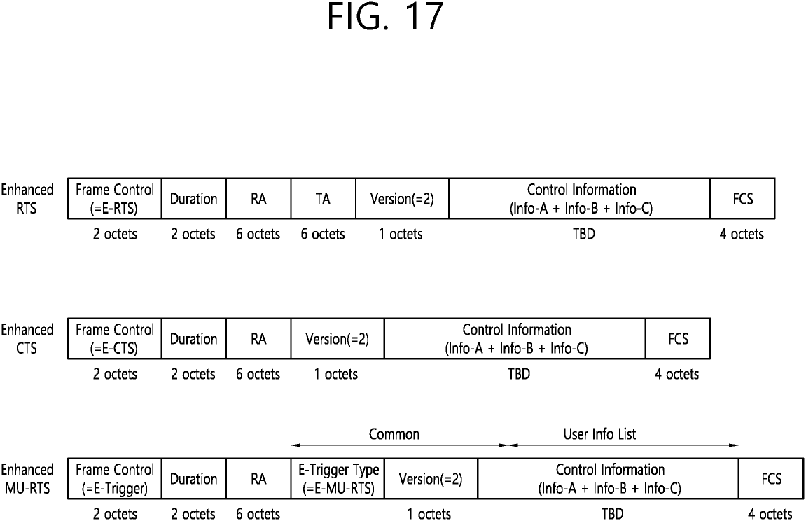

FIG. 17 is a diagram illustrating an example of an RTS/CTS/MU-RTS frame.

Referring to FIG. 17, in the example of Option 2, when Version = 2, Control Information may further include additional information (i.e., Info-C) to information Info-A + Info-B when Version = 1.

Therefore, if the STA that understands only Version = 0 (i.e., can decode) receives enhanced control frames such as E-RTS / E-CTS / E-MU-RTS when Version = 1 or Version = 2, the STA may obtain and use information (e.g., Info-A) when at least Version=0. When the STA that understands only Version = 1 receives enhanced control frames such as E-RTS / E-CTS / E-MU-RTS when Version = 2, at least, the STA may obtain and use information (e.g., Info-A+Info-B) when Version=1. If configured as in Option 1, the STA that understands only Version = 0 cannot know additional information even if it receives the control frame when version = 1 is used.

According to an example of the present specification, it is possible to solve the above-mentioned problem (that is, the problem in which the NAV is reset) by defining a value larger than the NAVTimeout value used in the existing system. For example, the RTS frame may include information related to a NAVTimeout value for STAs that will receive the RTS frame.

The new NAVTimeout can be set to a value larger than the existing NAVTimeout value ((2*aSIFSTime) + (CTS_Time) + aRxPHYStartDelay + (2*aSlotTime)) and can be set to one of the following values, but is not limited thereto.

1) (2*aSIFSTime) + (CTS_Time) + aRxPHYStartDelay + (2*aSlotTime): Set to the same value as before.

2) (2*aSIFSTime) + (CTS_Time) + aRxPHYStartDelay + (3*aSlotTime): Set to increase by 1 aSlotTime length.

3) (2*aSIFSTime) + (new CTS_Time) + aRxPHYStartDelay + (2*aSlotTime): Increase CTS_Time by replacing it with New CTS_Time.

4) (2*aSIFSTime) + (CTS_Time) + aRxPHYStartDelay + (N*aSlotTime): The N value may be included in MU-RTS/new MU-RTS/new Trigger/new RTS/RTS/other Trigger frames. The number of aSlotTime is determined based on the corresponding value. The default value of N is 2. (New) If the receiving terminal receiving the MU-RTS/RTS/Trigger frame includes an N value in the frame, it is multiplied by aSlotTime by the N value. If the N value is not included in the MU-RTS/new MU-RTS/RTS/New RTS frame, a value of N=2 is used.

5) (2*aSIFSTime) + (CTS_Time) + aRxPHYStartDelay + (2*aSlotTime) + (N*aSlotTime): The N value may be included in MU-RTS/new MU-RTS/new Trigger/new RTS/RTS/other Trigger frames, and the number of aSlotTime to be added may be determined based on the corresponding value. The default value of N is 0, and if the value N is included in the corresponding frame, the receiving terminal receiving the (New) MU-RTS/RTS/Trigger frame, may set a new NAVTimeout value by adding the value obtained by multiplying the existing NAVTimeout value by N by aSlotTime. If the value of N is not included in the MU-RTS/new MU-RTS/RTS/New RTS frame, a value of N=0 is used.

6) (2*aSIFSTime) + (2*CTS_Time) + aRxPHYStartDelay + (2*aSlotTime): Increase the existing CTS_Time time by one more time.

7) (2*aSIFSTime) + (CTS_Time) + aRxPHYStartDelay + (2*aSlotTime) + AdditionalTime (M) becomes the NAVTimeout value, an AdditionalTime (M) value may be included in the MU-RTS/RTS/new MU-RTS/new RTS frame. The unit of the AdditionalTime (M) value is preferably us, but may be set to a value higher than that (e.g., one of values between 1us and 16us).

The NAVTimeout value itself may be included in MU-RTS/new MU-RTS/new Trigger/new RTS/RTS/other Trigger frames, a NAVTimeout value may be determined based on the corresponding value.

The above examples are one example, and the terminal of the new system may set a new NAVTimeout value having a larger value than the existing NAVTimeout value instead of the existing NAVTimeout value using various methods other than the method defined above.

The multi-link device (MLD) described below may be the device of FIGS. 1 and/or 10, and the PPDU may be the PPDU of FIG. 9. The device may be an AP or a non-AP STA. The device described below may be an AP multi-link device (MLD) supporting multi-link or a non-AP STA MLD.

In extremely high throughput (EHT), a standard being discussed after 802.11ax, a multi-link environment using more than one band at the same time is being considered. When the device supports multi-link or multi-link, the device may use one or more bands (e.g., 2.4 GHz, 5 GHz, 6 GHz, 60 GHz, etc.) simultaneously or alternately.

Hereinafter, although described in the form of a multi-link, the frequency band may be configured in various other forms. Although terms such as multi-link and multi-link may be used in this specification, some embodiments may be described based on multi-link for convenience of description below.

In the following specification, MLD means a multi-link device. The MLD has one or more connected STAs and has one MAC service access point (SAP) that passes through an upper link layer (Logical Link Control, LLC). MLD may mean a physical device or a logical device. Hereinafter, a device may mean an MLD.

In the following specification, a transmitting device and a receiving device may refer to MLD. The first link of the receiving/transmitting device may be a terminal (e.g., STA or AP) that performs signal transmission/reception through the first link, included in the receiving/transmitting device. The second link of the receiving/transmitting device may be a terminal (e.g., STA or AP) that performs signal transmission/reception through the second link included in the receiving/transmitting device.

In IEEE802.11be, two types of multi-link operations can be supported. For example, simultaneous transmit and receive (STR) and non-STR operations may be considered. For example, the STR may be referred to as an asynchronous multi-link operation, the non-STR may be referred to as a synchronous multi-link operation. A multi-link may include a multi-band. That is, the multi-ink may mean a link included in several frequency bands, or may mean a plurality of links included in one frequency band.

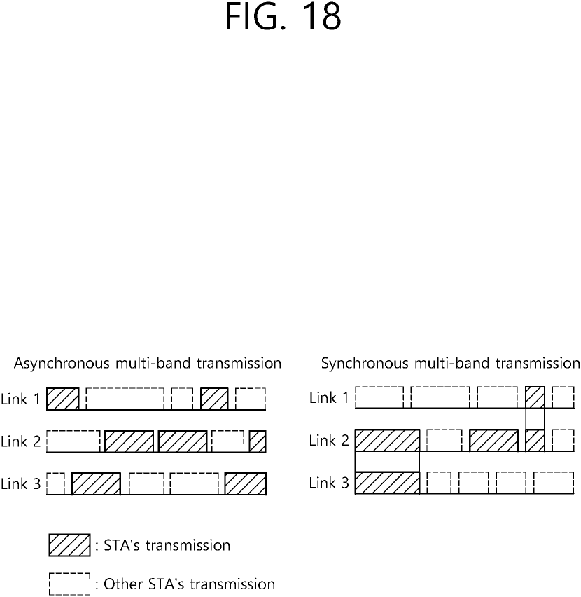

FIG. 18 is a diagram illustrating an embodiment of a multi-link transmission method.

Referring to FIG. 18 , the EHT (11be) considers a multi-link technology, where the multi-link may include a multi-band. That is, the multi-link may represent links of several bands and at the same time may represent several multi-links within one band. Two types of multi-link operation are being considered. Asynchronous operation that enables simultaneous TX/RX on multiple links and synchronous operation that is not possible are considered. Hereinafter, the capability that enables simultaneous reception and transmission in multiple links is called STR (simultaneous transmit and receive), a STA having STR capability is called a STR MLD (multi-link device), and a STA not having STR capability is called a non-STR MLD.

In the existing single-band/link situation, an Ack frame may be transmitted to the corresponding band or link. Therefore, when transmission is performed in two or more bands or links, it can be estimated that the Ack frame for the data of each link will operate link-specifically. However, in this case, there is a possibility that the Ack frame may be lost due to a power imbalance problem or a collision problem between the AP and the STA. In particular, the link quality of a specific link may have lower reliability than the link quality of other links due to frequency characteristics or the degree of OBSS density.

Meanwhile, simultaneous transmission and reception (STR) capability may vary based on characteristics of frequencies occupied by a plurality of links or capability of a terminal. More specifically, when the center frequency of a plurality of links is close or when one link is receiving data from another link due to a design problem inside each terminal, etc., interference may occur even if the frequencies/bands of the two links are different. Therefore, even if the AP has STR capability, it is necessary to design a channel access method in consideration of the situation in which the STA does not support the STR.

Meanwhile, in the process of improving the 802.11 WLAN standard, the data rate is also increasing, but the length of the PPDU is also greatly increased. In particular, when transmitting a PPDU of a large size in a dense environment in which a large number of STAs exist, if RTS/CTS is not used, the overall network throughput can be greatly reduced due to high probability of collision, so the use of RTS/CTS may be required.

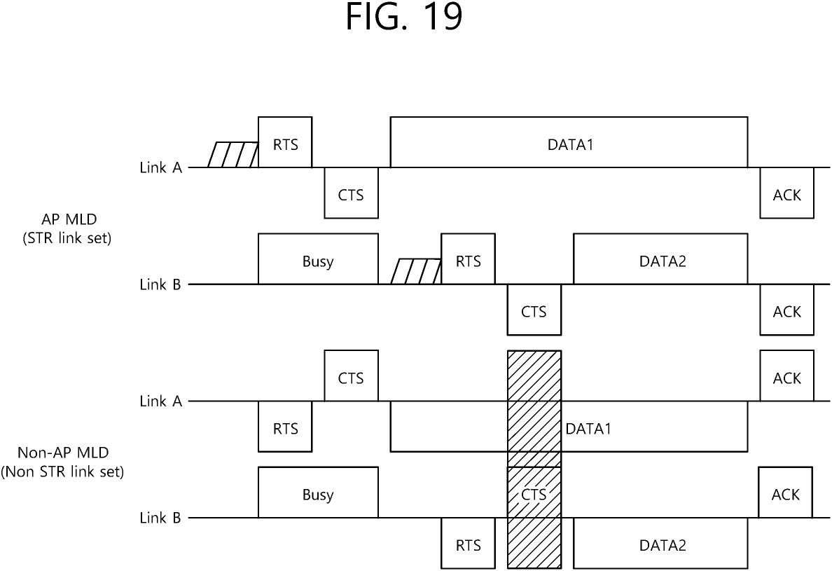

FIG. 19 is a diagram illustrating an embodiment of an inter-link interference situation of MLD.

FIG. 19 illustrates potential problems that may occur when two links perform channel access and data transmission/reception processes using RTS/CTS, respectively. Referring to FIG. 19, when the AP MLD starts transmission in the other link (i.e., link A) because one link (i.e., link B) is not idle, if AP MLD performs (MU-)RTS because the channel of another link (i.e., link A) becomes idle, the non-AP MLD should respond with CTS, but since link A and link B are non-STR link sets, CTS transmitted from link B may cause inter-link interference with link A being received.

SM (spatial multiplexing) power saving is a method capable of reducing power consumption through a relatively simple protocol. While there is no indication from the AP, if only one active receive chain is operated and an indication is received from the AP, by driving other receive chains that have been disabled, low power consumption and high throughput can be obtained at the same time.

SM power saving is classified into static SM power saving and dynamic SM power saving. Static SM power saving is a method of controlling an active chain of an STA through an explicit frame. In the 802.11 spec, as a frame for SM power saving, as an SM power save frame, or as an element for this, through the SM Power Save subfield in the HT Capabilities element of the (Re) Association Request frame, the AP may designate the STA to maintain only one active chain.

As mentioned above, based on the HE dynamic SM (Spatial Multiplexing) power saving operation defined in 11ax, a terminal supporting HE dynamic SM power saving responds to a Trigger frame addressing itself (that is, the AID of the terminal is included in the User Info field of the Trigger frame), the terminal may switch to multiple frame receive chain mode and switch to single frame receive change mode immediately after the frame exchange sequence is finished.

However, when the AP MLD transmits RTS or MU-RTS or other trigger frame (e.g., buffer status report poll (BSRP) or bandwidth query report poll (BQRP)) to non-STR non-AP MLD, the AP MLD may include and transmit information indicating that the STA, which is in non-STR non-AP MLD that has received RTS/MU-RTS/other Trigger frame, does not transmit a response frame (e.g., CTS, BSR frame, BQR frame).

The terminal instructed not to transmit the response frame in the RTS/MU-RTS/other Trigger frame may not transmit the response frame. Therefore, the corresponding terminal may not operate based on the method (that is, after transmitting the response frame, switching to multiple frame receive chain mode to receive multiple streams) defined in the dynamic SM power saving of the existing system (11ax or 11ac).

In an example of this specification, when the STA belonging to this non-STR non-AP MLD is in the dynamic SM power saving mode, the methods for switching to multiple frame receive chain mode after receiving the MU-RTS/another Trigger frame are defined.

Method 1: When the non-STR non-AP STA for which Dynamic SM power saving is enabled receives a frame indicating no response (e.g., MU-RTS/other Trigger frames (e.g., BSRP or BQRP), etc.), the non-STR non-AP STA may change from a single stream receive chain mode to multiple streams receive chain mode and may perform frame reception preparation. However, this method may not properly reflect the current channel state (physical carrier sensing result or virtual carrier sensing results) of the non-STR non-AP MLD or STA. For example, the primary channel of the link may be busy, the resource allocated by the trigger frame may be busy, or its NAV vale may be non-zero. In this case, the DL frame transmitted later may not be properly received or the UL frame may not be transmitted when UL resources are allocated. In this case, changing to multiple streams (frames) receive chain mode may cause unnecessary power consumption.

Method 2: When the non-STR non-AP STA for which Dynamic SM power saving is enabled receives a frame indicating no response (e.g., MU-RTS/other Trigger frames (e.g., BSRP or BQRP), etc.), after checking the carrier sensing result (PHY and Virtual), the STA may determine whether to change to multiple streams (frames) receive chain mode or not.

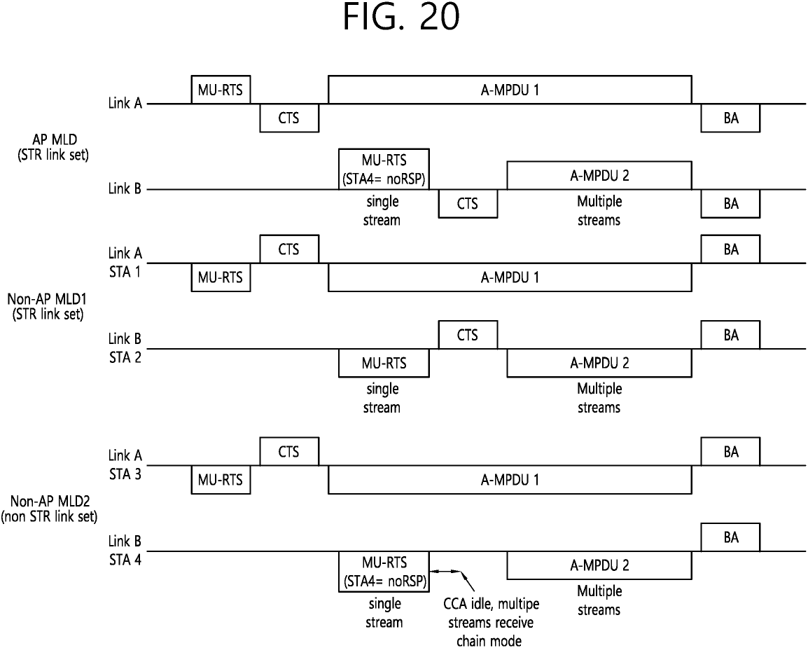

FIG. 20 is a diagram illustrating an example of an operation method of a non-AP STA that does not respond to an RTS/MU-RTS/Trigger frame.

Referring to FIG. 20, non-AP MLD 1 may have a STR relationship between link A and link B, and non-AP MLD 2 may have a non-STR relationship between link A and link B. AP MLD transmits in single streams chain mode when transmitting MU-RTS to link B, AP MLD may transmit information indicating no response to STA 4 (i.e., non CTS response) in the MU-RTS frame. When STA 2 receives the MU-RTS, STA 2 may transmit the CTS, and STA 4 may not transmit the CTS even after receiving the MU-RTS.

Thereafter, STA 4 may operate as follows.

If the carrier sensing result indicates busy, the corresponding terminal (non-STR non-AP STA 4) may maintain a single frame (stream) receive chain mode.

If the carrier sensing result indicates idle, the corresponding terminal (non-STR non-AP STA 4) can switch to multiple frames (streams) receive chain mode.

For MU-RTS frame or Trigger frame, non-AP MLD can check the channel status (idle or busy) by ED check during SIFS after receiving the frame.

STA 4 receives the MU-RTS, checks the carrier sensing result (e.g., physical carrier sensing or virtual carrier sensing of the primary channel), and then, STA4 may switch to multiple frames receive chain mode because the carrier sensing result is idle. If the carrier sensing result is busy, single frame (stream) receive chain mode can be maintained.

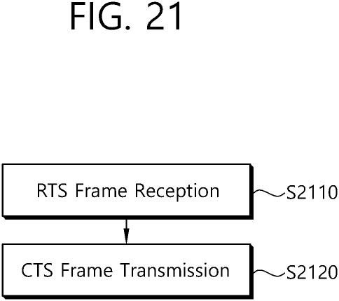

FIG. 21 is a diagram illustrating an embodiment of a method of operating a receiving STA.

Referring to FIG. 21, a receiving STA may receive an RTS frame (S2110). For example, the receiving STA may receive a request to send (RTS) frame, and the RTS frame may include information related to the length of the RTS frame. For example, the type of information included in the RTS frame may vary based on the length of the RTS frame. For example, the type of information included in the CTS frame may vary based on the length of the CTS frame. For example, the RTS frame may further include information related to the duration of the CTS frame. For example, the information related to the length of the RTS frame may further include information related to a WLAN system supported by the receiving STA transmitting the RTS frame. For example, the RTS frame may further include information that the RTS frame is an RTS frame.

### Method 1: Sufficient Reserved Fields Are Included in the Newly Defined RTS/CTS/MU-RTS Frame

### Method 2: Version Information Indication: Include Version Information in The Newly Defined RTS/CTS/MU-RTS

Depending on the Version information, information following the Version information may be different, and the overall length of the frame may be changed based on the included information. That is, the version information may be information related to the length of the frame, and the information related to the frame length may be version information. The Frame control field may include information on a frame type related to which frame the corresponding frame is among RTS/CTS/MU-RTS frames. Or, in the case of MU-RTS, the frame control field may only include information that the corresponding frame is a trigger frame, the E-trigger type field in front of the Version field may include information that the corresponding frame is an Enhanced-MU-RTS frame.

Before the version information appears, it is determined whether the frame is an RTS frame, a CTS frame, or a MU-RTS frame, so that the terminal may know this in advance, the terminal may know how the following information is configured, through Version information.

Although the size of the Version field is 1 octet, it is natural that it may have a different size (e.g., 4 bits or 16 bits). FIG. 12 shows an example in which Enhanced RTS/CTS/MU-RTS information is indicated in the Frame control field, but may be indicated in other forms.

The Frame Control field of the frame includes information called Extended Control frame, after FC (frame control), for example, one subtype field (e.g., Extended Control Subtype) in front of Version information may indicate that the frame is which type of frame (e.g., E-RTS, E-CTS, E-RTS, E-CTS, E-Trigger) among Extended Control frames. For example, if the Extended control subtype field includes information that the frame is E-trigger, a field subsequent to the extended control subtype field may include information related to which type of frame (e.g., E-MU-RTS frame) among E-trigger frames.

Also, in the above examples, the version information is located after TA in E-RTS and after RA in E-CTS, but the version information may be included in a different form or in a different location.

Version information may be indicated using, for example, one or more fields of Frame Control, Duration, RA, and TA. As another example, when configured in the above Extended Control frame format, Version information may be indicated using some bits of Extended Control Subtype. For example, if the Frame control field of a frame contains information related to extended control, the corresponding frame may include an extended control type field, and the extended control type field may include a subtype field and a version field. Here, the subtype field may include information that the corresponding frame is an E-RTS or E-CTS frame, the version field may include information related to the version of the corresponding frame. Alternatively, if the Frame control field of the frame includes the Extended control field, the corresponding frame may include the Extended control subtype field, when the extended control subtype field indicates a trigger frame type, the extended control subtype field may further include a continuous E-trigger type field. For example, the E-trigger type field may include information that the corresponding frame is an E-MU-RTS frame, the version field subsequent to the E-trigger type field may include information related to the version of the corresponding frame.

### Method 3: Include Length Information in the Frame

Frame may include length instead of Version. Alternatively, both version information and length information may be included. If the length of control information of E-RTS/E-CTS/E-MU-RTS previously defined is different from the Control information of the newly defined E-RTS/E-CTS/E-MU-RTS frame, based on the Length value, the terminal may determine whether to obtain Control information from the received E-RTS//E-CTS/E-MU-RTS. For example, if terminal A can only know the Control Information structure for Length=X, when a control frame including Control Information with Length = Y is received, terminal A cannot obtain Control Information, and only knows what type of frame (e.g., E-RTS/E-CTS/E-MU-RTS) the corresponding frame is. If terminal B can know the control information structure for Length=X and Length=Y, when receiving a control frame for Length=X or Y, it can obtain information included in the frame. That is, the information related to the frame length may include the type of the corresponding frame and information included in the corresponding frame.

According to an example of the present specification, when version information is included in a new control frame of specific types, when the terminal of the previous version receives the frame of the same type of the later version, although it is not possible to accurately obtain the information included in Control Information, at least it is possible to know which frame the received frame is an extended version of. For example, if the terminal receiving the frame knows that the frame is an E-RTS or E-MU-RTS frame, after the previous version terminal receives the new version of E-RTS or E-MU-RTS and sets the NAV, if it does not receive PHY-RXSTART. Indication during the NAVTimeout, the terminal may reset the NAV. That is, the frame may include information related to the type of the corresponding frame (e.g., RTS, CTS, MU-RTS, etc.) and information related to version (or length).

### Method for Configuring Control Information Field Information Based on Version Information

Option 1: Control Information is configured regardless of version.

For example, the control information of the previous version may not be included in the frame of the next version. In this case, the terminal that understands only the control frame of the previous version may not be able to decode the control frame included in the control frame of the new version.

Option 2: The control information of the next version includes the control information of the previous version.

For example, if Control Information of Version = 1 includes punctured channel information, versions after Version = 2 may always include punctured channel information. In this case, the control information of the lower version (e.g., version = 1) may be located before the control information of the higher version (e.g., version = 2). That is, the information of the next version may be included immediately following the control information of the previous version. This method has an advantage in that STAs designed in the previous version can obtain at least control information that they understand even if they receive the frame of the next version.

In the example of Option 2, when Version 0, Control information may include Info-A (e.g., Punctured channel information).

In the example of Option 2, when Version = 1, Control Information may include additional information (Info-B) in addition to information Info-A when Version = 0.

In the example of Option 2, when Version = 2, Control Information may further include additional information (i.e., Info-C) to information Info-A + Info-B when Version = 1.

Therefore, if the STA that understands only Version = 0 (i.e., can decode) receives enhanced control frames such as E-RTS / E-CTS / E-MU-RTS when Version = 1 or Version = 2, the STA may obtain and use information (e.g., Info-A) when at least Version=0. When the STA that understands only Version = 1 receives enhanced control frames such as E-RTS / E-CTS / E-MU-RTS when Version = 2, at least, the STA may obtain and use information (e.g., Info-A+Info-B) when Version=1. If configured as in Option 1, the STA that understands only Version = 0 cannot know additional information even if it receives the control frame when version = 1 is used.

According to an example of the present specification, it is possible to solve the above-mentioned problem (that is, the problem in which the NAV is reset) by defining a value larger than the NAVTimeout value used in the existing system. For example, the RTS frame may include information related to a NAVTimeout value for STAs that will receive the RTS frame.

The new NAVTimeout can be set to a value larger than the existing NAVTimeout value ((2*aSIFSTime) + (CTS_Time) + aRxPHYStartDelay + (2*aSlotTime)) and can be set to one of the following values, but is not limited thereto.

1) (2*aSIFSTime) + (CTS_Time) + aRxPHYStartDelay + (2*aSlotTime): Set to the same value as before.

2) (2*aSIFSTime) + (CTS_Time) + aRxPHYStartDelay + (3*aSlotTime): Set to increase by 1 aSlotTime length.

3) (2*aSIFSTime) + (new CTS_Time) + aRxPHYStartDelay + (2*aSlotTime): Increase CTS_Time by replacing it with New CTS_Time.

4) (2*aSIFSTime) + (CTS_Time) + aRxPHYStartDelay + (N*aSlotTime): The N value may be included in MU-RTS/new MU-RTS/new Trigger/new RTS/RTS/other Trigger frames. The number of aSlotTime is determined based on the corresponding value. The default value of N is 2. (New) If the receiving terminal receiving the MU-RTS/RTS/Trigger frame includes an N value in the frame, it is multiplied by aSlotTime by the N value. If the N value is not included in the MU-RTS/new MU-RTS/RTS/New RTS frame, a value of N=2 is used.

5) (2*aSIFSTime) + (CTS_Time) + aRxPHYStartDelay + (2*aSlotTime) + (N*aSlotTime): The N value may be included in MU-RTS/new MU-RTS/new Trigger/new RTS/RTS/other Trigger frames, and the number of aSlotTime to be added may be determined based on the corresponding value. The default value of N is 0, and if the value N is included in the corresponding frame, the receiving terminal receiving the (New) MU-RTS/RTS/Trigger frame, may set a new NAVTimeout value by adding the value obtained by multiplying the existing NAVTimeout value by N by aSlotTime. If the value of N is not included in the MU-RTS/new MU-RTS/RTS/New RTS frame, a value of N=0 is used.

6) (2*aSIFSTime) + (2*CTS_Time) + aRxPHYStartDelay + (2*aSlotTime): Increase the existing CTS_Time time by one more time.

7) (2*aSIFSTime) + (CTS_Time) + aRxPHYStartDelay + (2*aSlotTime) + AdditionalTime (M) becomes the NAVTimeout value, an AdditionalTime (M) value may be included in the MU-RTS/RTS/new MU-RTS/new RTS frame. The unit of the AdditionalTime (M) value is preferably us, but may be set to a value higher than that (e.g., one of values between 1us and 16us).

The NAVTimeout value itself may be included in MU-RTS/new MU-RTS/new Trigger/new RTS/RTS/other Trigger frames, and the NAVTimeout value may be determined based on the corresponding value.

The receiving STA may transmit a CTS frame (S2120). For example, the receiving STA may transmit a clear to send (CTS) frame, and the CTS frame may include information related to the length of the CTS frame.

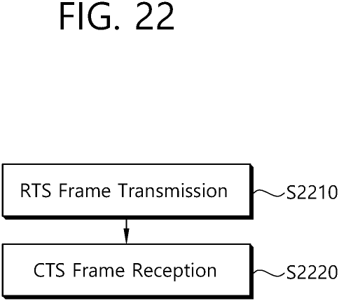

FIG. 22 is a diagram illustrating an embodiment of a method of operating a transmitting STA.

Referring to FIG. 22, a transmitting STA may transmit an RTS frame (S2210). For example, the transmitting STA may receive a request to send (RTS) frame, and the RTS frame may include information related to the length of the RTS frame.

The transmitting STA may receive the CTS frame (S2220). For example, the transmitting STA may transmit a clear to send (CTS) frame, and the CTS frame may include information related to the length of the CTS frame.

Some of the detailed steps shown in the example of FIGS. 21 and 22 may not be essential steps and may be omitted. In addition to the steps shown in FIGS. 21 and 22 , other steps may be added, and the order of the steps may vary. Some of the above steps may have their own technical meaning.

The technical features of the present specification described above may be applied to various devices and methods. For example, the above-described technical features of the present specification may be performed/supported through the apparatus of FIG. 1 and/or 10. For example, the technical features of the present specification described above may be applied only to a part of FIGS. 1 and/or 10. For example, the technical features of the present specification described above are implemented based on the processing chips 114 and 124 of FIG. 1 , or implemented based on the processors 111 and 121 and the memories 112 and 122 of FIG. 1, or, may be implemented based on the processor 610 and the memory 620 of FIG. 10. For example, in the apparatus of the present specification, the processor comprises: receiving a request to send (RTS) frame, wherein the RTS frame includes information related to a length of the RTS frame; and, transmitting a clear to send (CTS) frame, and the CTS frame may be configured to include information related to the length of the CTS frame.

The technical features of the present specification may be implemented based on a CRM (computer readable medium). For example, CRM proposed by the present specification is at least one processor of a non-AP (access point) STA (station) multi-link device (MLD) of a wireless local area network (WLAN) system. In at least one computer-readable recording medium including instructions based on being executed by the at least one processor may include: receiving a request to send (RTS) frame, wherein the RTS frame includes information related to a length of the RTS frame; and transmitting a clear to send (CTS) frame, the CTS frame may include information related to the length of the CTS frame.

The instructions stored in the CRM of the present specification may be executed by at least one processor. At least one processor related to CRM in the present specification may be the processors 111 and 121 or the processing chips 114 and 124 of FIG. 1, or the processor 610 of FIG. 10. Meanwhile, the CRM of the present specification may be the memories 112 and 122 of FIG. 1, the memory 620 of FIG. 10 or a separate external memory/storage medium/disk.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot j oint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims set forth herein may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method performed in a wireless local area network (WLAN) system, the method performed by a receiving station (STA) and comprising:
receiving a request to send (RTS) frame, wherein the RTS frame includes information related to a length of the RTS frame; and
transmitting a clear to send (CTS) frame, wherein the CTS frame includes information related to the length of the CTS frame.

2. The method of claim 1,
wherein type of information included in the RTS frame varies based on the length of the RTS frame.

3. The method of claim 1,
wherein type of information included in the CTS frame varies based on the length of the CTS frame.

4. The method of claim 1,
wherein the RTS frame further includes information related to the duration of the CTS frame.

5. The method of claim 1,
wherein the information related to the length of the RTS frame further includes information related to a wireless LAN system supported by the receiving STA transmitting the RTS frame.

6. The method of claim 1,
wherein the RTS frame further includes information that the RTS frame is an RTS frame.

7. A receiving STA (station) in a wireless LAN system, the receiving STA comprising:
a transceiver for transmitting and receiving a radio signal; and
a processor coupled to the transceiver, the processor is adapted to perform the following operations:
receiving a request to send (RTS) frame, wherein the RTS frame includes information related to a length of the RTS frame; and
transmitting a clear to send (CTS) frame, wherein the CTS frame includes information related to the length of the CTS frame.

8. The receiving STA of claim 7,
wherein type of information included in the RTS frame varies based on the length of the RTS frame.

9. The receiving STA of claim 7,
wherein type of information included in the CTS frame varies based on the length of the CTS frame.

10. The receiving STA of claim 7,
wherein the RTS frame further includes information related to the duration of the CTS frame.

11. The receiving STA of claim 7,
wherein the information related to the length of the RTS frame further includes information related to a wireless LAN system supported by the receiving STA transmitting the RTS frame.

12. The receiving STA of claim 7,
wherein the RTS frame further includes information that the RTS frame is an RTS frame.

13. (canceled)

14. A transmitting station (STA) in a wireless LAN system, the transmitting STA comprising:
a transceiver for transmitting and receiving a radio signal; and
a processor coupled to the transceiver, the processor is adapted to perform the following operations:
transmitting a request to send (RTS) frame, wherein the RTS frame includes information related to a length of the RTS frame; and
receiving a clear to send (CTS) frame, wherein the CTS frame includes information related to the length of the CTS frame.

15-16. (canceled)
